(19) United States
(12) Patent Application Publication
(10) Pub. No.: US 2002/0060249 A1
(43) Pub. Date: May 23, 2002

(54) Authentication device with transmission speed synchronization capabilities

(75) Inventor: David Perron, Quebec City (CA)

Correspondence Address: HESLIN ROTHENBERG FARLEY & MESITI PC, 5 COLUMBIA CIRCLE, ALBANY, NY, 12203, US

(73) Assignee: Tel+ Systeme Inc., Quebec City (CA)

(21) Appl. No.: 09/976,281

(22) Filed: Oct. 12, 2001

Related U.S. Application Data
(63) Continuation-in-part of application No. 09/721,458, filed on Nov. 22, 2000.

(30) Foreign Application Priority Data
Nov. 22, 1999 (CA) 2,290,184

(51) Int. Cl. G06K 19/06

(52) U.S. Cl. 235/492; 235/380

(57) ABSTRACT

The authentication device, for example a card, is powered by a battery and is provided with an internal clock to control operations of its microcontroller. The device comprises a contact interface, such as a ISO 7816 interface, through which data is transmitted to a reader. The device may also comprise one or more additional interfaces, in particular an acoustic interface.

In use, the microcontroller generates a data stream to be outputted through one of the interfaces of the device. When the device is used with a reader, the device is capable of transmitting the bits of the data stream through the contact interface in a synchronized fashion in spite of the fact that the reader and the device are using their own clock, both of which operate at a speed which is not precisely known in advance.

### CROSS-REFERENCE WITH PRIOR APPLICATION

This is a continuation-in-part of U.S. patent application No. 09/721,458 filed Nov. 22, 2000, which is hereby incorporated by reference.

### FIELD OF THE INVENTION

The present invention is concerned with an authentication device, preferably having the dimensional format established for “smart cards” in International Standard ISO 7816, which device provides data through a terminal for the purpose of establishing the authorization of an end user to conduct a transaction with a system.

### BACKGROUND

Credit cards and debit cards are widely used to conduct transactions with computerized systems. In the conduct of such transactions, a conventional credit card is typically authenticated by simple possession of the card. Only in rare instances the end user is asked to provide a proof that he or she is indeed the legitimate end user or the user's signature is verified in a thorough and adequate manner. A conventional debit card is somewhat more secure since it is authenticated by a personal identification number (PIN) in addition to the possession thereof. However, many people do not properly hide the keys when they input in their PIN on a terminal so that a person standing nearby or even the cashier may learn it. Some criminals even record PINs using a hidden camera.

In both above-mentioned cases, it is possible for criminals to create fake cards and use them in addition to the original and valid cards since the data unique to each card is a fixed string that can be recorded and copied from its magnetic stripe using a portable or otherwise illicit magnetic stripe reader. The recording or copy can then be used to make a fraudulent access to a transaction system, usually without any difficulties, since the system typically assumes that any valid data stream comes from a genuine card. Consequently, a counterfeited credit or debit card may be used to illegally purchase valuable goods or services, generally until the time the theft is detected by proper authorities or when the credit limit is reached.

<<Smart cards>> solve some of the inherent security weaknesses of conventional credit and debit cards by being capable of exchanging information with a transaction system in a secure manner. Among others, smart cards are able to communication with a transaction system using information that are unique to each transaction.

The transfer of data between a smart card and a transaction system may be achieved in various ways. The most general technique currently employed uses the ISO 7816 bidirectional electrical interface provided on the card, allowing serial communication between the card and the reader. The interface comprises a plurality of contact pads which are connected to an electronic circuitry embedded in the card. The reader is provided with electric contacts, each engaging a respective contact pad on the card when the card is inserted therein.

A smart card reader includes a clock to control its internal operations and the operation of the microcontroller of conventional passive smart cards since they are not provided with their own clock. The clock of the reader is hereinafter called <<external clock>>. The external clock signal is transmitted to the card through one of the contact pads of the ISO 7816 interface. Power is also transmitted to conventional passive smart cards through the ISO 7816 interface. As a result, conventional passive smart cards do not require an internal power source and an internal clock. Moreover, the use of the external clock synchronizes the transmission of data between a card and a reader since they operate at the same clock speed.

Yet, further techniques for the transfer of data involve an acoustic interface comprising an acoustic transducer generally operating at telephone voice frequencies. The acoustic interface enables communication between cards and a transaction system by acoustic coupling through a telephone handset or any other suitable communication terminal. Each card generates its own acoustic signal and is used in an autonomous manner. The cards are thus provided with an internal power source, typically a battery, and a control means for triggering the operation of the microcontroller. The control means are usually comprising a switch, in particular a finger-activated switch. Activating the switch causes an audio sequence to be generated by the microcontroller and sent to the acoustic transducer in the form of electrical signals. All these tasks require that the microcontroller be provided with an internal clock to control its operations.

Building a card, or any other similar device, using both an ISO 7816 interface and an acoustic interface presents some challenges and difficulties. One of them is the exchange of data between a card and a card reader when communicating through the ISO 7816 interface. Since both of them are using a different clock, and since the clock signals are at a frequency which is not precisely known in advance, a synchronization of the transmission speed is needed.

One possible solution for the synchronization of the transmission speed is to provide each card with a microcontroller having the ability to automatically switch from an internal clock to an external clock source. Using the external clock source allows to keep the data transfer between both the card and the reader in a synchronized fashion. However, microcontrollers with such capabilities are not widely available on the market and an alternate solution had to be devised to obviate this problem.

### SUMMARY

The object of the present invention is to provide an authentication device relying on an internal clock to control its microcontroller while still being able to communicate in a synchronized fashion with a card reader through a contact interface. It is also an object of the present invention to provide a corresponding method.

Further features of the authentication device and corresponding method will be apparent from following detailed description of preferred and possible embodiments thereof.

### BRIEF DESCRIPTION OF THE FIGURES

FIG. 1 is a plan view of a device in accordance with a preferred and possible embodiment;

FIG. 2 is a side elevation view of the device, with its thickness exaggerated to facilitate illustration;

FIG. 3 is a simplified schematic circuit diagram of the device in accordance with a first embodiment thereof;

FIG. 4 is a simplified schematic circuit diagram of the device in accordance with a second embodiment thereof;

FIG. 5 is a simplified timing diagram concerning an example of a first possible embodiment of the synchronization;

FIG. 6 is a simplified timing diagram showing an example of the differences between an external and an internal clock signal for purpose of synchronization;

FIG. 7a is a simplified timing diagram concerning an example of a second possible embodiment of the synchronization;

FIG. 7b is a view similar to FIG. 7a, showing an example of a variant of the second embodiment; and

FIG. 7c is a view similar to FIG. 7a, showing an example of another variant of the second embodiment.

### DETAILED DESCRIPTION

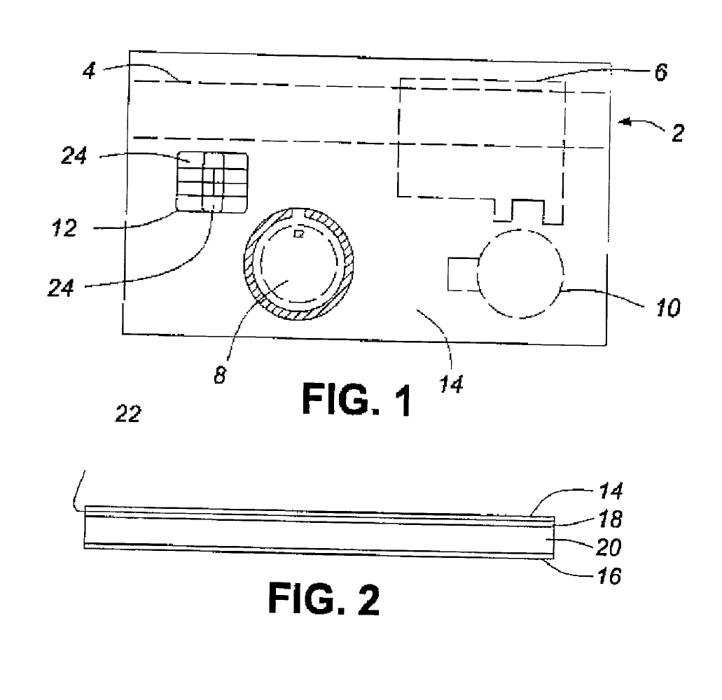

FIGS. 1 and 2 show a preferred embodiment of the authentication device, in this case a card 2. This card 2 is preferably built to be conformed with the ISO 7816 standard or any subsequent version or applicable standard. Thus, the card 2 is preferably designed to use the existing reader infrastructure or network and has a thickness of about 0.76 mm, as specified in the standard. The card 2 may also comprise a magnetic stripe 4 to transmit some information in a conventional fashion if required. Of course, it is possible to design a card which is for use only in a specific application and that would not be compatible with conventional readers.

The card 2 is manufactured in accordance with any known techniques in the art, such as by injection, machining, cold or hot lamination, molding, or even a combination of them. It preferably features a laminated construction, which essentially comprises a core layer sandwiched between two or more other layers. For instance, it may comprise a front layer 14, a rear layer 16, a circuit board layer 18 and a core layer 20, as shown in FIG. 2. The layers are connected together by layers of adhesive, such as the layer 22. The adhesive may be, for instance, a glue or a filler, activated by light, heat or both. The components necessary for the card 2 to function are thus embedded or otherwise made inaccessible therein. The various layers are preferably made of a plastic material, such as PCV, polyester, ABS or the like. The faces of the card 2 may be printed either in advance or at a later time.

It should be noted that the term <<terminal>> refers to almost any kind of apparatus through which the card 2, or device, may communicate in order to reach the transaction system. It may be located at a point-of-sale (POS) or any other location, particularly when the terminal is a telephone apparatus. Also, the expression <<transaction system>> means any computer or cluster of computers, as well as any similar systems, carrying out the tasks of authentication and the ones related to the transaction itself. The term <<transaction>> relates to any relevant task and is not limited to monetary transactions. For instance, it may include granting an access, such as unlocking a door, or anything else of similar nature. Further, the expression <<authentication device>> includes cards, tokens or any other devices for which the present invention may be useful.

Depending on the specific needs, the card 2 comprises an internal power source, such as a battery 6, having enough energy to last for the life thereof. The card 2 also comprises a first and a second data output device, namely an acoustic transducer element 8 and a contact interface 12, preferably an ISO 7816 interface, an activation device, such as a finger-operated switch 10, and a microcontroller 26 which is preferably mounted behind the contact interface 12. The contact interface 12 includes contact surfaces or pads 24 in an area presented through a front surface layer 14 of the card 2. All components are electrically connected together, for instance through a flexible circuit board embedded in the card 2. Some of the pads 24 of the contact interface 12 are linked to the microcontroller 26 through other connections thereof.

The microcontroller 26 includes a core 33 where the internal processing occurs. It also includes an internal clock 34 to generate an internal clock signal for controlling the operations of core 33 and other components on the card 2 requiring such signal. The microcontroller 26 also includes an I/O interface 36 to which the acoustic transducer element 8 and the contact interface 12 are connected.

The exact kind of microcontroller 26 depends essentially on the available models when the card is designed and the design requirements. A possible model for the microcontroller 26 is model MSP430P112 from TEXAS INSTRUMENTS. The microcontroller 26 comprises a program memory 30 that is programmable through programming readouts or through the contact interface 12, depending on the model. However, such programming is not required in the case a mask-programmed microcontroller, such as model MSP430C112, which is more suitable for mass-produced cards. The microcontroller 26 is programmed with code to provide desired functionality of the card 2 to communicate with a transaction system through a terminal, such communication being through either the contact interface 12 or the acoustic transducer element 8.

The memory 30 on the device may be for example a one-time programmable memory (OTP), a read-only memory (ROM), a FLASH memory, erasable programmable read-only memory (EPROM) or an electrically erasable programmable read-only memory (EEPROM). The program memory 30 can also be located in a module outside the microcontroller 26 itself. The exact design of the memory and the nature thereof is something well known in the art and does not need to be further detailed herein.

It should be noted that the design of the battery 6 may be different from that shown in FIG. 1, for example to allow letters, numbers and symbols to be embossed on the card 2, if required, as in the case of most conventional credit or debit cards. The layout of the other components on the card 2 may be different.

The acoustic transducer element 8 is designed to generate tone sequences, generally at voice frequencies, enabling communication between the card 2 and a transaction system by acoustic coupling through a telephone handset or any other suitable communication terminal. It may also be used at other frequencies, in particular higher frequencies, depending on the applications.

Preferably, in the acoustic mode, the card 2 is temporarily activated, i.e. switched on, using the switch 10, which typically comprises a flexible membrane or a piezoelectric pressure sensor closing a circuit when a finger pressure is applied. This sends an activation signal to the microcontroller 26. Rather than simply switching on the card 2, it is also possible to provide a keypad for a PIN or any other additional security feature, including for instance a biometrics sensor. Other kinds of activation devices may be used as well.

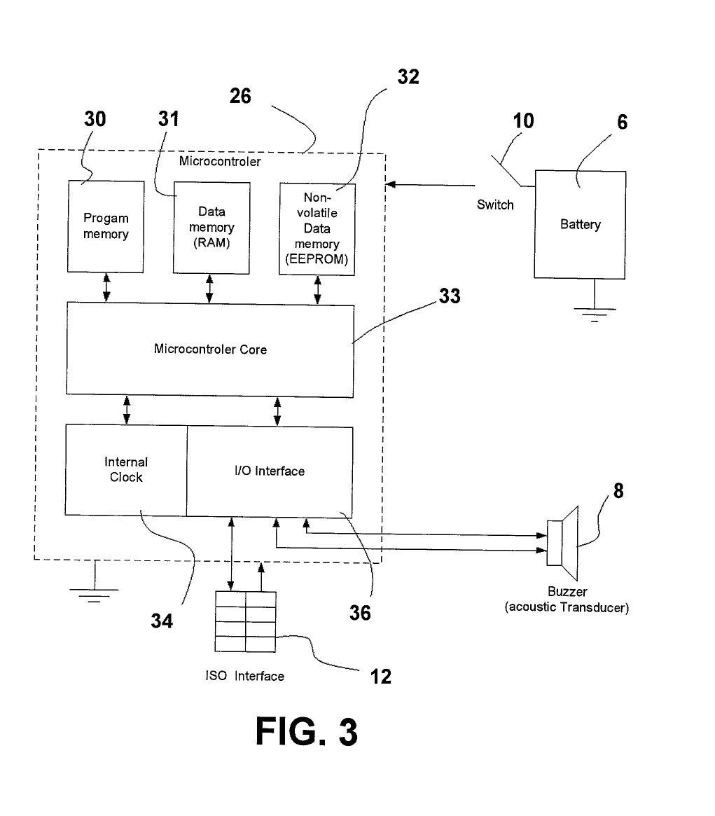

In FIG. 3, the switch 10 is simply located between the battery 6 and the microcontroller 26. Closing the switch 10 powers the microcontroller 26 for a brief moment, which is generally enough for carrying out its functions. FIG. 3 also shows a random-access memory (RAM) 31 which is used by the microcontroller 26. In the embodiment illustrated in FIG. 3, the personalization data are stored in a non-volatile data memory 32, more particularly an EEPROM.

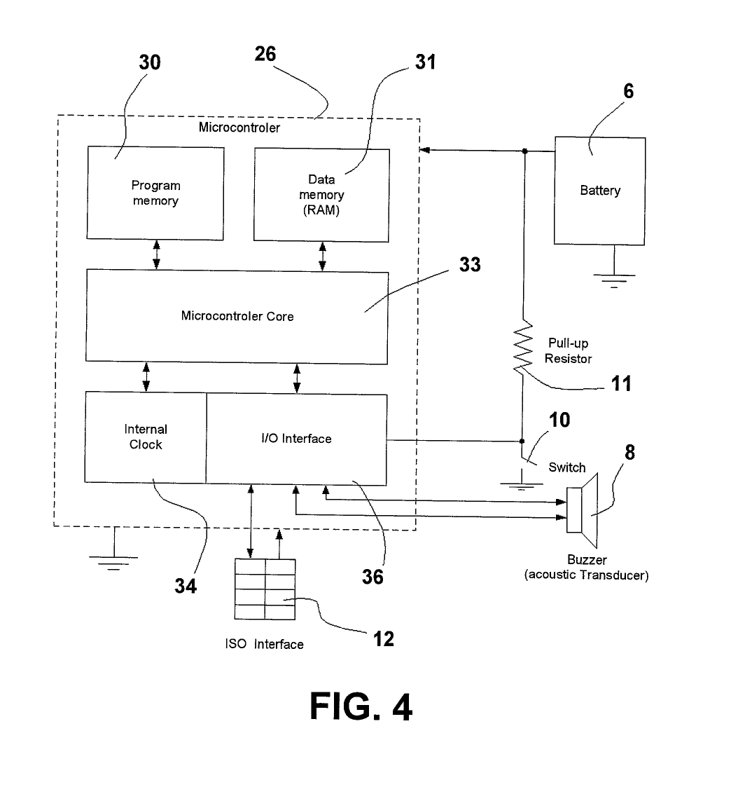

In FIG. 4, the switch 10 is combined with a pull-up resistor 11. The activation signal is generated when the switch 10 is closed and the voltage variation is sensed by an I/O interface 36. It has a connection located between the switch 10 and the pull-up resistor 11.

Typically, upon activation of the card 2, the serial number or any other identification number and the updated counter value are obtained from the corresponding memory of the card 2, such as the RAM 31 or the EEPROM 32, to form portions of a data stream, including a signature, that is to be transferred to the transaction system. The microcontroller 26 produces sequences of electrical signals corresponding to the data stream and sends them to the I/O interface 36, where they are sent to the acoustic transducer element 8.

When the card 2 is used with a terminal having a smart card reader, the connections established through the contact interface 12 generally cause the card 2 to be activated upon insertion in the reader. For instance, the microcontroller 26 may sense the external clock signal through one of the contact pads or the voltage applied to another. From there, the microcontroller 26 generates the data stream like in the case of the acoustic mode. Although the external clock signal is available, the microcontroller 26 always relies on its internal clock to operate. Yet, the card 2 may or not draw power through the interface.

The internal clock is preferably within the microcontroller 26, other embodiments being possible as well. It typically provides a clock frequency within a range of about 20% from a target value. As a result, the clock frequency varies from card to card and cannot be predetermined exactly. As for the external clock, it is also varying from terminal to terminal. The clock signal is generally produced by a vibrating crystal and varies from 1 MHz to 5 MHz, other embodiments and values being also possible. A typical and common value is 3,57 MHz. Since both the internal and external clock speeds as not known in advance, it is necessary to synchronize the transmission speed of the data stream with the speed of the reader when data is transmitted through the contact interface 12. More than one embodiment is possible to achieve this goal, as explained hereinafter.

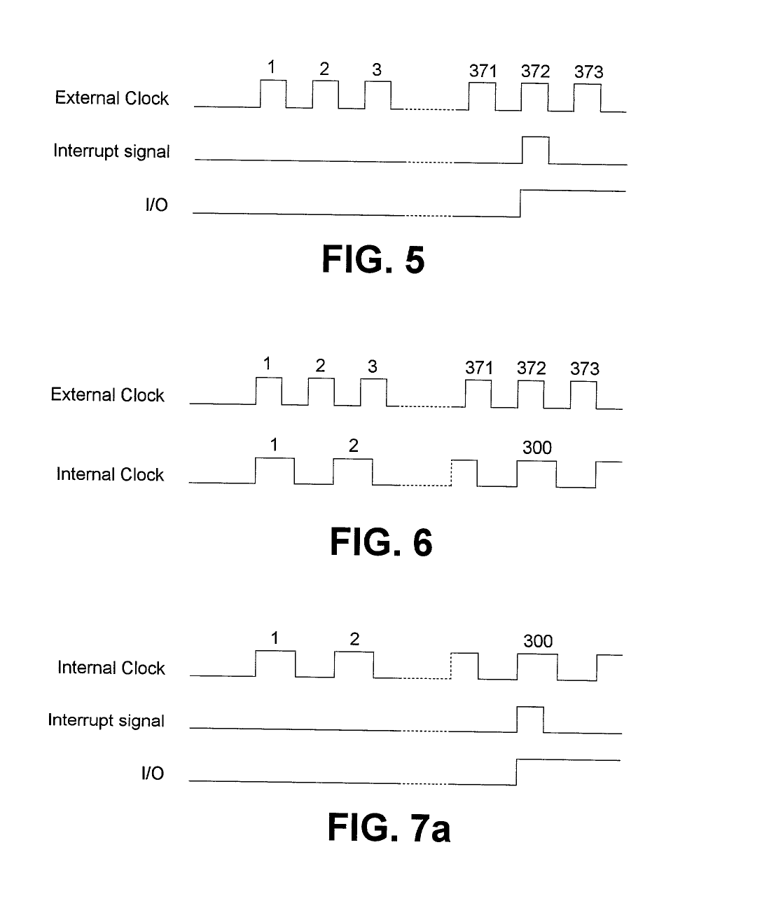

An example of a first possible embodiment of the transmission speed synchronization is schematically illustrated in FIG. 5. In this embodiment, a microcontroller implemented timer senses and keeps count of the external clock cycles and sends an interrupt signal after a given number of external clock cycles to the microcontroller 26 or a multiple thereof, depending if the count is reset to zero. The number is preferably 372, although other values can be used as well. This number allows a transmission speed of 9600 bauds when the external clock is set at the common value of 3.57 MHz. Sending an interrupt signal triggers the transmission of a bit of the data stream by the microcontroller 26 through the contact interface 12. These steps are repeated until all bits are transmitted.

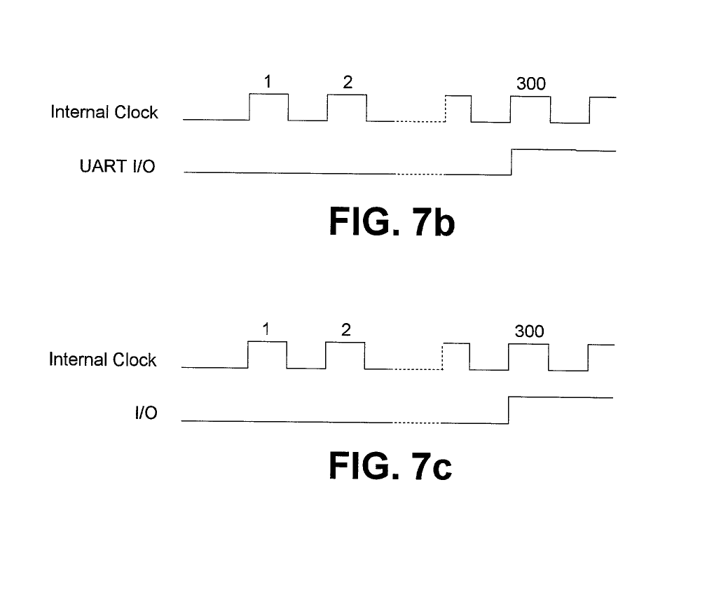

An example of a second possible embodiment is schematically illustrated in FIGS. 6 and 7a. In this embodiment, the microcontroller 26 compares the external clock signal with the internal clock signal to determine a conversion factor between them. For instance, in the illustrated example, 300 internal clock cycles is the equivalent of 372 external clock cycles. From there, a microcontroller implemented timer keeps count of the internal clock cycles and sends an interrupt signal after the number of internal clock cycles corresponding to the conversion factor. In the example, the interrupt is sent after 300 internal clock cycles. Sending an interrupt signal triggers the transmission of a bit of the data stream by the microcontroller 26 through the contact interface 12. These steps are repeated until all bits are transmitted.

A possible variant of the second embodiment is to use a UART (Universal Asynchronous Receiver-Transmitter) unit, whose transmission rate is set by the conversion factor, as the I/O interface 36. The UART unit is clocked by the internal clock 34 since it is located on the card 2. It then sends a bit of the data stream until all bits are transmitted, as illustrated in FIG. 7b. It should be noted that the UART unit could be clocked by the external clock signal, in which case a conversion factor will not be needed. However, such arrangement is not presently available on the market.

A further possible variant of the second embodiment is use a microcontroller implemented timer to sense the external clock signal and with a microcontroller implemented program that executes a number of predetermined software loops of a subroutine that corresponds in length to the number of internal clock cycles given by the conversion factor, taken into account the number of cycles required for the transmission of the bit of data by the microcontroller 26. A bit of the data stream is transmitted by the microcontroller 26 through the contact interface 12 once the software loops are completed, as illustrated in FIG. 7c. These steps are repeated until all bits are transmitted.

It is interesting to note that the reader may also be used to send data to the card 2. The principles underlying the synchronization of the transmission speed also applies in these circumstances since the reader transmits data at the same speed than that when it receives data from the card 2.

It should be understood that the implementations of many of the features of the above-described authentication device are exemplary only. Considerable variations are possible within the scope of the present invention, various features of which may be used independently or in different combination. Moreover, the term <<card>> used in the detailed description is only as an example and the present invention is not limited to cards only. It is also possible to manufacture a device which communicates only through the contact interface 12 but which still comprises an internal clock for controlling operations of the microcontroller 26.

What is claimed is:

1. An authentication device for a transaction system, the transaction system including at least one reader generating a first clock signal and establishing a data transmission path with the device through a contact interface, the clock signal being transmitted through the contact interface, the device operating in accordance with a second clock signal, the device comprising:
first means for sensing the first clock signal;
second means for generating a data stream;
third means for transmitting bits of the data stream through the contact interface; and
fourth means for synchronizing the transmission of the bits of the data stream with the first clock signal.

2. A device in accordance with claim 1, wherein first, second, third and fourth means are provided on a microcontroller.

3. A device in accordance with claim 1, wherein the fourth means comprise means for counting cycles of the first clock signal.

4. A device in accordance with claim 3, wherein the fourth means comprise means for sending an interrupt signal upon reaching a given number of cycles of the first clock signal, the third means being responsive of the interrupt signal for transmitting each bit of data.

5. A device in accordance with claim 4, wherein the contact interface includes a ISO 7816 interface.

6. A device in accordance with claim 1, wherein the fourth means comprise:
(A) means for determining a conversion factor indicative of a number of cycles of the second clock signal equivalent to a predetermined number of cycles of the first clock signal;
(B) means for counting cycles in the second clock signal; and
(C) means for sending an interrupt signal to the third means when the number of cycles of the second clock signal equals that of the conversion factor, the third means being responsive of the interrupt signal for transmitting each bit of data.

7. A device in accordance with claim 6, wherein the contact interface includes a ISO 7816 interface.

8. A device in accordance with claim 1, wherein the third means comprise an UART unit located on the device and controlled by the second clock signal.

9. A device in accordance with claim 8, wherein the fourth means comprise:
(A) means for determining a conversion factor indicative of a number of cycles of the second clock signal equivalent to a predetermined number of cycles of the first clock signal; and
(B) means for transmitting the conversion factor to the UART unit.

10. A device in accordance with claim 9, wherein the contact interface includes a ISO 7816 interface.

11. A device in accordance with claim 2, wherein the microcontroller is programmed for:
(A) determining a number of software loops of a subroutine needed for matching in length a predetermined number of cycles of the first clock signal;
(B) executing the number of software loops;
(C) transmitting a bit of data through the contact interface when the software loops are completed; and
(D) repeating (B) and (C) at least until all bits of data are transmitted.

12. A device in accordance with claim 11, wherein the contact interface includes a ISO 7816 interface.

13. A method of synchronizing the data transmission speed between an authentication device and a reader of a transaction system, the reader generating a first clock signal and the device generating a second clock signal, both for controlling respective operations thereof, the method comprising:
establishing a data transmission path between the reader and the device through a contact interface;
sensing the first clock signal through the contact interface; and
determining the data transmission speed based at least on the first clock signal.

14. A method in accordance with claim 13, wherein determining the data transmission speed comprises counting cycles in the first clock signal.

15. A method in accordance with claim 14, further comprising:
(A) sending an interrupt signal after a given number of cycles of the first clock signal;
(B) transmitting a bit of data; and
(C) repeating (A) and (B) at least until all bits of data are transmitted.

16. A method in accordance with claim 12, wherein determining the data transmission speed comprising:
(A) determining a conversion factor corresponding to a number of cycles of the second clock signal equivalent to a predetermined number of cycles of the first clock signal;
(B) counting cycles in the second clock signal;
(C) sending an interrupt signal when the number of cycles of the second clock signal equals the conversion factor;
(D) transmitting a bit of data; and
(E) repeating (C) and (D) at least until all bits of data are transmitted.

17. A method in accordance with claim 12, wherein determining the data transmission speed comprising:
(A) determining a conversion factor corresponding to a number of cycles of the second clock signal equivalent to a predetermined number of cycles of the first clock signal;
(B) transmitting the conversion factor to a UART unit located on the device and controlled by the second clock signal; and
(C) using the UART unit for transmitting the data in accordance with the conversion factor.

18. A method in accordance with claim 12, wherein determining the data transmission speed comprising:
(A) on a microcontroller located on the device, determining a number of software loops of a subroutine needed for matching in length a predetermined number of cycles of the first clock signal;
(B) executing the number of software loops;
(C) transmitting a bit of data when the software loops are completed; and
(D) repeating (B) and (C) at least until all bits of data are transmitted.
